(19) United States
(12) Patent Application Publication
(10) Pub. No.: US 2014/0189181 A1
(43) Pub. Date: Jul. 3, 2014

(54) On-Chip Bus Arbitration Method and Device Thereof

(71) Applicants: Xu Cheng, Beijing (CN); Dan Liu, Beijing (CN); Yi Feng, Beijing (CN); Dong Tong, Beijing (CN)

(72) Inventors: Xu Cheng, Beijing (CN); Dan Liu, Beijing (CN); Yi Feng, Beijing (CN); Dong Tong, Beijing (CN)

(73) Assignee: BEIJING PKUNITY MICROSYSTEMS TECHNOLOGY CO., LTD., Beijing (CN)

(21) Appl. No.: 14/124,792

(22) PCT Filed: Oct. 14, 2011
(86) PCT No.: PCT/CN11/80810

§ 371 Date: Feb. 28, 2014

(30) Foreign Application Priority Data
Jun. 7, 2011 (CN) 201110150606.X

(51) Int. Cl. G06F 13/362

(52) U.S. Cl. CPC G06F 13/3625
USPC 710/118

(57) ABSTRACT

A method and device for on-chip bus arbitration are disclosed. The method includes: dividing devices into a first level, a second level and a third level from high to low; and in each arbitration period, calculating remaining processing time of each real-time transaction, and upgrading a device making a request required to be processed immediately to the first level in the current arbitration period; monitoring bandwidth usage amount of devices of the first level and the second level respectively, and downgrading a device whose bandwidth usage amount exceeds a preset bandwidth threshold value to the third level in the current arbitration period; and in devices making requests for a bus use right, if a device of the highest level is the device of the first level, authorizing the device of the first level; and if it is not the device of the first level, authorizing a device making continuous requests.

### TECHNICAL FIELD

The present invention relates to the field of computer, and specifically, to a method and device for on-chip bus arbitration.

### BACKGROUND OF THE RELATED ART

With the increase of integration requirements of Computer, Communication and Consumer electronic (3C) and the enhancement of integration level of semiconductor process, more and more functional components such as a display controller, a media accelerator and various mainstream input output controllers, etc. are integrated in system chips. Under the guidance of the intellectual property reuse methodology, a bus communication protocol of the industrial grade standard is generally used to design an on-chip communication structure in these system chips. In that type of system chips, all the display controller, the media accelerator and the input output controllers are required to perform lots of data interactions with the memory, which makes memory access become a performance bottleneck of the system. Meanwhile, since memory access transactions of all the devices are sent to a memory controller through a bus, the bus arbitration has significant influence on the memory access performance.

A Synchronous Dynamic Random Access Memory (SDRAM) or its upgraded type memory is generally used as the memory in the system chips. An execution sequence of memory access operations decides the times of the memory switching row addresses and read-write types, thereby deciding the memory access performance. The energy consumption of the memory is mainly from row address switching. In order to optimize the memory access sequence, many memory controllers all use the memory access scheduling technology to perform out-of-order scheduling on the memory access transactions in a buffer queue. However, due to the limitation of depth of the buffer queue, a scope of the memory access scheduling is generally and comparatively limited. Through an analysis of communication behaviors of the devices in the system chips, it is discovered that multiple pending transactions sent by the same device always have continuous addresses and identical read-write types. However, in a traditional bus arbitration method, it mainly concerns how to simultaneously satisfy requirements of all the devices on the communication service quality and does not consider that characteristic, which causes that sequences of the pending transactions sent by these devices are always interleaved after going through the bus arbitration and cannot be sent to the memory controllers continuously. Meanwhile, since it is difficult for the memory controllers to observe all the pending transactions sent by the same device within a limited scheduling scope, it is very difficult to completely recover the interleaved transactions to the original pending transaction sequence, which eventually causes that the sequences of the pending transactions sent by the same device and having the continuous addresses and identical read-write types generally cannot be continuously sent to the memory. With the increase of the number of devices in the system chips and the enhancement of performance requirements, the problem of the traditional bus arbitration method will cause that optimization effects of the memory access scheduling become more unobvious.

Many communication devices with high bandwidth, low latency or real-time requirements are integrated in the system chips. For example, the quantity demanded of bandwidths of a media acceleration type device is large, the latency of a processor should be as low as possible, and the display controller is required to transmit high bandwidth data in real time. How to satisfy the requirements of these devices on the bandwidth and latency simultaneously is mainly concerned in the traditional bus arbitration method. At present, popular bus arbitration methods include: static priority arbitration, Time Division Multiple Access (TDMA), Lottery, RB_Lottery, RT_Lottery, Quality of Service (QoS) arbitration and Slack-based QoS arbitration. Each method and its problems will be described respectively and briefly below.

The static priority arbitration: a fixed priority is allocated to each master device, and an arbiter selects a requester with the highest priority among all the requesters to grant the requester a bus use right. When multiple devices with high-bandwidth or low-latency make requests simultaneously, the static priority may cause that requirements of other devices cannot be satisfied while guaranteeing an absolute priority of an individual device.

TDMA: it is generally extended to a two-layer protocol. A time wheel is used in the layer 1, the usage time of the bus is divided into time slices on the time wheel, and each slice is allocated to a separate master device equally. If a possessor of the current time slice makes a request for the bus, the arbiter grants the possessor a use right of the time slice, otherwise the layer 2 protocol will grant the time slice to other master devices in a rotary way. The bandwidths can be allocated rationally to a certain degree with the method, but the time slice thereof has been fixedly allocated in advance, if a master device makes a request for the bus only after the rotation of a time slice belonging to the master device, the communication latency of the master device may be very large.

Lottery: with respect to the problems of the static priority arbitration and TDMA, a uniformly controlled “lottery manager” is used to arbitrate the bus use right according to a certain probability in the Lottery arbitration. Each master device will be allocated with a certain amount of lotteries according to its quantity demanded of bandwidths, and a master device with a larger quantity demanded of bandwidths will be allocated with more lotteries. The “lottery manager” will randomly extract a lottery from lotteries of all the requesters, and the extracted master device obtains the bus use right. The main problem thereof includes three aspects: 1) transmission of real-time devices cannot be guaranteed; 2) bandwidth allocation cannot be controlled accurately; 3) low-latency transmission requirements of devices with small quantity demanded of bandwidths cannot be guaranteed.

RT_Lottery: it is a two-layer arbitration protocol proposed with respect to the problem that the real-time transmission cannot be guaranteed in the Lottery. A layer 1 is mainly used for processing requests which have real-time requirements and are more urgent, and if the above type of requests do not exist at present, a layer 2 arbitration protocol will play a role. The layer 2 is comparatively similar to the Lottery, but the layer 2 is required to adjust the number of lotteries allocated to each master device through simulation before the implementation of hardware. The adjustment method is to iteratively allocate lotteries of a master device with the largest number of superfluous lotteries to a master device which is most lacking in lotteries.

RB_Lottery: it is a two-layer arbitration protocol proposed with respect to the problem that the bandwidth allocation cannot be controlled correctly in the Lottery and RT_Lottery. A layer 1 is mainly used for processing requests which have real-time requirements and are more urgent, and if the requests of above type do not exist at present, a layer 2 arbitration protocol will play a role. The layer 2 is comparatively similar to the layer 2 of the RT_lottery, but a bandwidth adjuster is added in the implementation of hardware at the layer 2. According to the size of a time window set by a user and the bandwidth demand of the master device within one time window, the bandwidth adjuster checks whether the bus bandwidth allocated to each master device within the current time window reaches the demand of the master device. If the bus bandwidth allocated to each master device within the current time window has reached the demand of the master device, the bandwidth adjuster will intercept a request sent by the master device to a bus arbitration within the remaining time of the current window. With the RB_Lottery, the requirement of real-time transmission can be guaranteed, and the bandwidth allocation can be controlled correctly, but the low-latency transmission requirements of devices with small quantity demanded of bandwidths cannot be guaranteed.

QoS arbitration: it is an arbitration method proposed with respect to the problem that the low-latency transmission requirements of devices with small quantity demanded of bandwidths cannot be guaranteed with the series of Lottery arbitration methods. In the method, requirements of the device on the quality of service are, from high to low, divided into 3 QoS levels: priority, bandwidth and best-effort, the priority corresponds to a low-latency communication device, the bandwidth corresponds to a high-bandwidth communication device, and the best-effort corresponds to a communication device without strict requirements on latency and bandwidth, and arbitration is performed cooperatively through two parts namely the bandwidth allocation components and the arbitration components. The bandwidth allocation components calculate the bandwidth usage condition of devices of the first two levels, and a device with the excessive bandwidth usage amount is downgraded to a device of the best-effort level. The arbitration components perform arbitration according to the level of each device after the adjustment, and the devices of the same level follows a Least Recently Serviced (LRS) principle. A main problem of the QoS arbitration is that guaranteeing transmission of the real-time devices through the high priority in the QoS arbitration method may lead to raising communication latency of other devices.

Slack-based QoS arbitration: since guaranteeing the transmission of the real-time devices through the high priority in the QoS arbitration may lead to the raising communication latency of other devices, with respect to the problem, an independent real-time scheduling component is added based on the QoS arbitration in the Slack-based QoS arbitration. The component is responsible for calculating remaining processing time of each real-time transaction and upgrading a device required to be processed immediately as a priority device.

Though the requirements of all the devices on the communication service quality can be guaranteed in the Slack-based QoS arbitration, under the action of the LRS principle, sequences of the pending transactions sent by all the devices are always interleavingly sent to the memory controller. However, the memory controller cannot observe all the pending transactions sent by the same device within the limited scheduling scope, thus, it is very difficult to recover the interleaved transactions to the original transaction sequence, which eventually causes that the sequences of the pending transactions sent by the same device and having the continuous addresses and identical read-write types generally cannot be sent to the memory continuously.

### SUMMARY OF THE INVENTION

The technical problem required to be solved by the present invention is how to perform on-chip bus arbitration, to optimize the memory access performance while guaranteeing the communication service quality.

In order to solve the above problem, the present invention provides a method for on-chip bus arbitration, which comprises:

dividing devices into a first level, a second level and a third level from high to low; and

in each arbitration period, executing the following steps:

calculating remaining processing time of each real-time transaction, and upgrading a device making a request required to be processed immediately to the first level in the current arbitration period;

monitoring a bandwidth usage amount of a device of the first level and a bandwidth usage amount of a device of the second level, and downgrading a device whose bandwidth usage amount exceeds a preset bandwidth threshold value to the third level in the current arbitration period; and

in devices making requests for a bus use right, when a device of the highest level is the device of the first level, authorizing the device of the first level; and when the device of the highest level is not the device of the first level, authorizing a device making continuous requests;

wherein, the continuous requests are requests whose read-write types are the same as that of a last authorized transaction, and whose addresses hit the same row or different memory banks as an address of a last authorized transaction does.

Preferably, the step of authorizing a device making continuous requests comprises:

if no authorization period device exists, authorizing a device making continuous requests among devices of the highest level;

if a device whose level is higher than that of the authorization period device makes a request, authorizing a device making continuous requests among devices of the higher level; and

when no device of the higher level makes a request, judging whether a authorization period device makes continuous requests, if the authorization period device makes the continuous requests, authorizing the authorization period device; and if the requests made by the authorization period device are discontinuous requests, authorizing a device making continuous requests among devices of the highest level;

wherein, the authorization period device refers to that:

when no authorization period device exists, and a device of the second level or a device of the third level is authorized, the authorized device is a authorization period device;

when a authorization period device exists, in a condition that the device whose level is higher than that of the authorization period device does not make a request, if the authorization period device makes continuous requests, or if the authorization period device does not make a request and a time interval between the current time and the moment at which the authorization period device made a request last time does not exceed a transaction interval of the authorization period device, the authorization period device is still a authorization period device; and

when a authorization period device exists and it is not the above case that the authorization period device is still a authorization period device, if a device of the second level or a device of the third level is authorized, the authorized device is a authorization period device;

wherein, the transaction interval is an interval existing between pending transactions sent by the same device.

Preferably, the step of authorizing a device making continuous requests further comprises:

when a authorization period device exists and a device whose level is higher than that of the authorization period device does not make a request, if the authorization period device does not make a request, and when a time interval between the current time and the moment at which the authorization period device made a request last time does not exceed a transaction interval of the authorization period device, judging whether a device making continuous requests exists, if a device making continuous requests exists, authorizing the device making continuous requests, and if the device making continuous requests does not exist, not performing authorization.

Preferably, the step of authorizing a device making continuous requests further comprises:

when no device of the higher level makes a request, the authorization period device does not make a request, and a time interval between the current time and the moment at which the authorization period device made a request last time exceeds a transaction interval of the authorization period device, judging whether other requests exist; if no any other request exists, not performing authorization; if other requests exist and a device of the highest level makes continuous requests, authorizing a device making continuous requests; and if no continuous requests made by the device of the highest level exist among the other requests, performing authorization according to a Least Recently Serviced (LRS) principle.

Preferably, the step of authorizing a device making continuous requests further comprises:

if no authorization period device exists and a device of the highest level does not make continuous requests, performing authorization according to the LRS principle;

if a device whose level is higher than that of the authorization period device does not make continuous requests, performing authorization according to the LRS principle; and

when no device of the higher level makes a request, and requests made by the authorization period device are discontinuous requests, if a device of the highest level does not make continuous requests, performing authorization according to the LRS principle.

The present invention further provides a device for on-chip bus arbitration, which comprises:

a setting module, configured to: divide devices into a first level, a second level and a third level from high to low;

a real-time scheduling module, configured to: in each arbitration period, calculate remaining processing time of each real-time transaction, and upgrade a device making a request required to be processed immediately to the first level in the current arbitration period;

a bandwidth allocation module, configured to: in each arbitration period, monitor a bandwidth usage amount of a device of the first level and a bandwidth usage amount of a device of the second level, and downgrade a device whose bandwidth usage amount exceeds a preset bandwidth threshold value to the third level in the current arbitration period; and

a limited maintaining authorization arbitration module, configured to: in each arbitration period, after the real-time scheduling module and the bandwidth allocation module adjust the levels, in devices making requests for a bus use right, when a device of the highest level is the device of the first level, authorize the device of the first level; and when the device of the highest level is not the device of the first level, authorize a device making continuous requests; wherein, the continuous requests are requests whose read-write types are the same as that of a last authorized transaction, and whose addresses hit the same row or different memory banks as an address of the last authorized transaction does.

Preferably, the limited maintaining authorization arbitration module is further configured to authorize the device making continuous requests in the following way:

if no authorization period device exists, the limited maintaining authorization arbitration module authorizing a device making continuous requests among devices of the highest level;

if a device whose level is higher than that of the authorization period device makes a request, the limited maintaining authorization arbitration module authorizing a device making continuous requests among devices of the higher level; and

when no device of the higher level makes a request, the limited maintaining authorization arbitration module judging whether a authorization period device makes continuous requests, if the authorization period device makes the continuous requests, authorizing the authorization period device; and if the requests made by the authorization period device are discontinuous requests, authorizing a device making continuous requests among devices of the highest level;

wherein, the authorization period device refers to that:

when no authorization period device exists, and a device of the second level or a device of the third level is authorized, the authorized device is a authorization period device;

when a authorization period device exists, in a condition that the device whose level is higher than that of the authorization period device does not make a request, if the authorization period device makes continuous requests, or if the authorization period device does not make a request and a time interval between the current time and the moment at which the authorization period device made a request last time does not exceed a transaction interval of the authorization period device, the authorization period device is still a authorization period device; and

when a authorization period device exists and it is not the above case that the authorization period device is still a authorization period device, if a device of the second level or a device of the third level is authorized, the authorized device is a authorization period device;

wherein, the transaction interval is an interval existing between pending transactions sent by the same device.

Preferably, the limited maintaining authorization arbitration module is further configured to: when a authorization period device exists and a device whose level is higher than that of the authorization period device does not make a request, if the authorization period device does not make a request, and when a time interval between the current time and the moment at which the authorization period device made a request last time does not exceed a transaction interval of the authorization period device, judge whether a device making continuous requests exists, if a device making continuous requests exists, authorize the device making continuous requests, and if the device making continuous requests does not exist, not perform authorization.

Preferably, the limited maintaining authorization arbitration module is further configured to: when no device of the higher level makes a request, the authorization period device does not make a request, and a time interval between the current time and the moment at which the authorization period device made a request last time exceeds a transaction interval of the authorization period device, judge whether other requests exist; if no any other requests exists, not perform authorization; if other requests exist and a device of the highest level makes continuous requests, authorize a device making continuous requests; and if no continuous requests made by the device of the highest level exist among the other requests, perform authorization according to a Least Recently Serviced (LRS) principle.

Preferably, the limited maintaining authorization arbitration module comprises: a continuity calculation unit, a continuity screening unit, a timeout judgment unit, priority arbitration units, a multiple-choice device, a device number update unit and a state machine; wherein:

the continuity calculation unit is configured to: obtain a row address and read-write type of a transaction sequence authorized in the last arbitration period from the state machine, calculate whether a row address of each request and a row address of the last authorized transaction are identical or access different memory banks and whether a read-write type of each request and a read-write type of the last authorized transaction are identical, and eventually obtain continuity calculation results corresponding to all the devices, wherein, 1 represents continuity and 0 represents discontinuity; the results form continuity vectors; and requests of the device of the first level are defaulted as discontinuous.

the continuity screening unit is configured to: obtain a level of a device currently making a request from the state machine, and screen continuity state vectors of a current request of the highest level from the continuity vectors, and send the continuity state vectors to the state machine;

the priority arbitration units comprise a first priority arbitration unit, a second priority arbitration unit and a third priority arbitration unit; the first priority arbitration unit is configured to: input a request status of each device and a bitwise-and result of the continuity state vectors screened by the continuity screening unit, and calculate a first authorization result; the second priority arbitration unit is configured to: input a request status of each device and a bitwise-and result of continuity vectors of a request of the device of the highest level, and calculate a second authorization result; and the third priority arbitration unit is configured to: directly input a request status of each device, and calculate a third authorization result; wherein, the request status is that: 1 represents that a request is made, and 0 represents that there is no request;

the multi-choice device is configured to: select one of the first authorization result, the second authorization result, the third authorization result and 0 to serve as a current authorization result to be output according to an indication of the state machine, and input the current authorization result to the timeout judgment unit and the device number update unit;

the device number update unit is configured to: when the multi-choice device selects the current authorization result, according to the current authorization result, a number of devices of each level and an LRS sequence of devices of an identical level at the current moment obtained from the state machine, update a priority order among the devices for the next arbitration;

the timeout judgment unit is configured to: calculate how many periods had passed from the moment at which a device in the authorization period made the last request to the current moment, and judge whether a number of the periods exceeds a transaction interval of the device, and input a judgment result to the state machine; and

the state machine is configured to: determine an authorization situation which should be currently adopted by an arbiter according to state information of the state machine, the continuity vectors, the continuity state vectors, levels and the request statuses, and indicate the multi-choice device to make choices.

In the technical scheme of the embodiment of the present invention, the Slack-based QoS arbitration is improved, by continuously authorizing the sequences of the pending transactions sent by the same device and having the identical row addresses and read-write types in devices except the devices of the first level, it is guaranteed that this kind of transaction sequences are sent uninterruptedly to the memory controller, thereby reducing the times of the memory switching row addresses and read-write types and optimizing the memory access efficiency.

### BRIEF DESCRIPTION OF DRAWINGS

FIG. 1 is a flow diagram of the method for on-chip bus arbitration according to the embodiment 1.

FIG. 2 is a schematic diagram of a work flow of a limited maintaining authorization arbitration module in the embodiment 2.

FIG. 3 is a schematic diagram of a hardware structure of a limited maintaining authorization arbitration module in the embodiment 2.

### PREFERRED EMBODIMENTS OF THE PRESENT INVENTION

The technical scheme of the present invention will be described in detail in combination with the accompanying drawings and embodiments below.

It should be noted that the embodiments of the present invention and all the characteristics in the embodiments can be combined with each other in the condition of no conflict and they are all within the protection scope of the present invention. In addition, the steps illustrated in the flow diagram of the accompanying drawings can be executed in a computer system such as a group of computer executable instructions. Moreover, though a logic sequence is shown in the flow diagram, in some cases, the illustrated or described steps can be executed in a sequence different from here.

### Embodiment 1

A method for on-chip bus arbitration includes:

dividing devices into a first level, a second level and a third level from high to low; and

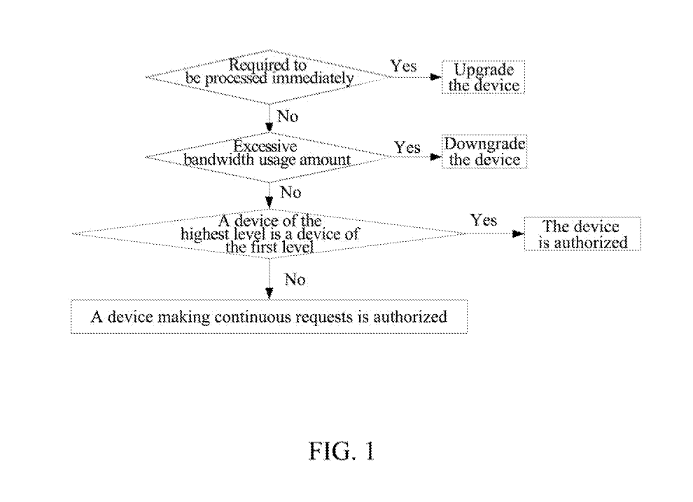

in each arbitration period, as shown in FIG. 1, executing the following steps:

calculating remaining processing time of each real-time transaction, and upgrading a device making a request required to be processed immediately to the first level in the current arbitration period;

monitoring a bandwidth usage amount of a device of the first level and a bandwidth usage amount of a device of the second level, and downgrading a device whose bandwidth usage amount exceeds a preset bandwidth threshold value to the third level in the current arbitration period;

wherein, a sequential order of the above two steps can be unlimited; and

in devices making requests for a bus use right, when a device of the highest level is the device of the first level, authorizing the device of the first level; and when the device of the highest level is not the device of the first level, authorizing a device making continuous requests;

wherein, with regard to the continuous requests, if a read-write type of a certain request is the same as a read-write type of a last authorized transaction, and an address of the request and an address of the last authorized transaction hit the same row or different memory banks, the requests are called as continuous requests.

The embodiment is mainly, but not limited to being used in a system chip design which adopts an SDRAM or an upgraded type memory thereof as a shared memory and an on-chip bus as a system communication structure.

In the embodiment, the first level, the second level and the third level can be but not limited to being called as a priority level, a bandwidth level and a best-effort level; the devices can be but not limited to being divided into the priority level, the bandwidth level and the best-effort level according to requirements of the devices on the quality of service; the requirements of the devices on the quality of service mainly include the following two aspects: bandwidth and latency; the priority level corresponds to devices with low-latency requirements, such as a processor; the bandwidth level corresponds to devices with high-bandwidth requirements, such as various media accelerators and high-speed Input/Output (I/O) controllers; and the best-effort level corresponds to devices without strict requirements on bandwidth and latency, such as a low-speed I/O controller.

In the embodiment, without departing from requirements on communication latency of a device sending a certain real-time transaction, the remaining processing time of the real-time transaction can be a maximum number of periods which can be used for processing the real-time transaction. The bandwidth usage amount of the device can be the number of periods for a certain device to occupy the bus for transmission within a previous time window (i.e., within a period of time with fixed length); and the preset bandwidth threshold value can be the number of bus periods allocated by a designer to the device.

A concept of authorization period is introduced in the embodiment, in an arbitration process, if it is not in an authorization period of any device (that is, no authorization period device exists), when the device of the second level or the device of the third level is authorized, it is to enter into the authorization period of the authorized device, the authorized device is a authorization period device; and if the device of the first level is authorized or no device is authorized, it is a situation that no authorization period exists (that is, no authorization period device exists).

If it is in an authorization period of one device (that is, a authorization period device exists), it is divided into the following situations:

(1). if a device whose level is higher than that of the authorization period device does not make a request, and the authorization period device makes continuous requests, the authorization period device can preferentially obtain a bus authorization, the arbitration process is still in the authorization period of the authorization period device, and the authorization period device is still a authorization period device;

(2). if a device whose level is higher than that of the authorization period device does not make a request, the authorization period device does not make a request, and a time interval between the current time and the moment at which the authorization period device made a request last time does not exceed a transaction interval of the authorization period device, the arbitration process is still in the authorization period of the authorization period device, and the authorization period device is still a authorization period device; and

(3). in other situations, when the device of the second level or the device of the third level is authorized, it is to enter into the authorization period of the authorized device, the authorized device is a authorization period device; and if the device of the first level is authorized or no device is authorized, it is a situation that no authorization period exists.

The other situations in the above (3) include:

a device whose level is higher than that of the authorization period device makes a request;

a device whose level is higher than that of the authorization period device does not make a request, and requests made by the authorization period device are discontinuous requests; and

a device whose level is higher than that of the authorization period device does not make a request, the authorization period device does not make a request, and a time interval between the current time and the moment at which the authorization period device made a request last time has exceeded a transaction interval of the authorization period device.

In the situation (2), if continuous requests exist among the requests made by other devices, a device making the continuous requests is authorized, if continuous requests do not exist among the requests made by other devices, no authorization is performed.

In the situation (3), the device of the first level making the request is preferentially authorized; if no device of the first level makes the request, the device making the continuous requests among devices of the highest level is preferentially authorized; and if a device of the highest level does not make the continuous requests, authorization is performed according to the LRS principle.

The transaction interval is defined as an interval existing between the pending transactions sent by the same device due to reasons such as clock frequency and communication interface design and so on, and it can be an empirical value.

In the embodiment, the step of authorizing a device making continuous requests can specifically include:

if no authorization period device exists, authorizing a device making continuous requests among devices of the highest level;

if a device whose level is higher than that of the authorization period device makes a request, authorizing a device making continuous requests among devices of the higher level; and

when no device of the higher level makes a request, judging whether a authorization period device makes continuous requests, if the authorization period device makes the continuous requests, authorizing the authorization period device; and if the requests made by the authorization period device are discontinuous requests, authorizing a device making continuous requests among devices of the highest level.

In the embodiment, the step of authorizing a device making continuous requests can also include:

when no device of the higher level makes a request, the authorization period device does not make a request, and a time interval between the current time and the moment at which the authorization period device made a request last time exceeds a transaction interval of the authorization period device, judging whether other requests exist; if no any other request exists, not performing authorization; if other requests exist and a device of the highest level makes continuous requests, authorizing a device making continuous requests; and if no continuous requests made by the device of the highest level exist among the other requests, performing authorization according to the LRS principle.

In the embodiment, the step of authorizing a device making continuous requests can also include:

if no authorization period device exists and a device of the highest level does not make continuous requests, performing authorization according to the LRS principle;

if a device whose level is higher than that of the authorization period device does not make continuous requests, performing authorization according to the LRS principle; and

when no device of the higher level makes a request, and requests made by the authorization period device are discontinuous requests, if a device of the highest level does not make continuous requests, performing authorization according to the LRS principle.

In the embodiment, when there are multiple devices which can be authorized, authorization can always be performed according to the LRS principle. For example:

when a device of the highest level is the device of the first level and there exist multiple devices of the highest level, authorization is performed according to the LRS principle; or

when there exist multiple devices making the continuous requests, authorization is performed on the multiple devices making these requests according to the LRS principle.

That is to say, in the embodiment, in one arbitration period, when no device of the higher level makes the request, strategies of performing arbitration on the requests of the device of the second level or the device of the third level include:

strategy 1, if the authorization period device re-makes a request for the bus in the current period, and an address of the request and an address of the last authorized transaction hit the same row or different memory banks, and a read-write type of the request and a read-write type of the last authorized transaction are also identical, the device continues to obtain a bus authorization;

strategy 2, if the authorization period device does not make a request, and a time interval between the current time and the moment at which the device made a request last time (i.e., the moment at which the device enables its request signals) does not exceed a transaction interval of the device, the arbitration can authorize other devices which make the continuous requests, but the authorization period device is still regarded as a device in the authorization period; and

strategy 3, if the authorization period device re-makes a request for the bus in the current period, but an address of the request and an address of the last authorized transaction hit different rows or a read-write type of the request and a read-write type of the last authorized transaction are different, or the authorization period device does not make a request, and a time interval between the current time and the moment at which the device made a request last time (i.e., the moment at which the device enables its request signals) exceeds a transaction interval of the device, the arbitration preferentially authorizes a request whose row address and read-write type are the same as the row address and read-write type of the last authorized transaction. If there still exist multiple requests, arbitration is performed according to an LRS sequence.

### Embodiment 2

A device for on-chip bus arbitration includes:

a setting module, used to: divide devices into a first level, a second level and a third level from high to low;

a real-time scheduling module, used to: in each arbitration period, calculate remaining processing time of each real-time transaction, and upgrade a device making a request required to be processed immediately to the first level in the current arbitration period;

a bandwidth allocation module, used to: in each arbitration period, monitor a bandwidth usage amount of a device of the first level and a bandwidth usage amount of a device of the second level, and downgrade a device whose bandwidth usage amount exceeds a preset bandwidth threshold value to the third level in the current arbitration period; and

a limited maintaining authorization arbitration module, used to: in each arbitration period, after the real-time scheduling module and the bandwidth allocation module adjust the levels, in devices making requests for a bus use right, when a device of the highest level is the device of the first level, authorize the device of the first level; and when the device of the highest level is not the device of the first level, authorize a device making continuous requests; wherein, the continuous requests are requests whose read-write types are the same as that of a last authorized transaction, and whose addresses hit the same row or different memory banks as an address of the last authorized transaction does.

In the embodiment, the first level, the second level and the third level can be but not limited to being called as a priority level, a bandwidth level and a best-effort level; the devices can be but not limited to being divided into the priority level, the bandwidth level and the best-effort level according to requirements of the devices on the quality of service.

In the embodiment, the limited maintaining authorization arbitration module authorizing the device making continuous requests can specifically refer to:

if no authorization period device exists, the limited maintaining authorization arbitration module authorizing a device making continuous requests among devices of the highest level;

if a device whose level is higher than that of the authorization period device makes a request, the limited maintaining authorization arbitration module authorizing a device making continuous requests among devices of the higher level; and

when no device of the higher level makes a request, the limited maintaining authorization arbitration module judging whether a authorization period device makes continuous requests, if the authorization period device makes the continuous requests, authorizing the authorization period device; and if the requests made by the authorization period device are discontinuous requests, authorizing a device making continuous requests among devices of the highest level;

wherein, a definition of the authorization period device is the same as that in the embodiment 1.

In the embodiment, the limited maintaining authorization arbitration module can also be used to: when a authorization period device exists and a device whose level is higher than that of the authorization period device does not make a request, if the authorization period device does not make a request, and when a time interval between the current time and the moment at which the authorization period device made a request last time does not exceed a transaction interval of the authorization period device, judge whether a device making continuous requests exists, if a device making continuous requests exists, authorize the device making continuous requests, and if the device making continuous requests does not exist, not perform authorization.

In the embodiment, the limited maintaining authorization arbitration module can also be used to: when no device of the higher level makes a request, the authorization period device does not make a request, and a time interval between the current time and the moment at which the authorization period device made a request last time exceeds a transaction interval of the authorization period device, judge whether other requests exist; if no any other request exists, not perform authorization; if other requests exist and a device of the highest level makes continuous requests, authorize a device making continuous requests; and if no continuous requests made by the device of the highest level exist among the other requests, perform authorization according to an LRS principle.

In the embodiment, the limited maintaining authorization arbitration module can also be used to: when no authorization period device exists and a device of the highest level does not make continuous requests, perform authorization according to the LRS principle; when a device whose level is higher than that of the authorization period device does not make continuous requests, perform authorization according to the LRS principle; and when no device of the higher level makes a request, and requests made by the authorization period device are discontinuous requests, if a device of the highest level does not make continuous requests, perform authorization according to the LRS principle.

In the embodiment, when there are multiple devices which can be authorized, the limited maintaining authorization arbitration module can always perform authorization according to the LRS principle. For example:

when a device of the highest level is the device of the first level and there exist multiple devices of the highest level, authorization is performed according to the LRS principle; or

when there exist multiple devices making the continuous requests, authorization is performed on the multiple devices making these requests according to the LRS principle.

The descriptions will be made through a specific example below, the levels in the example are called as the QoS levels, the first level is called as the priority level, the second level is called as the bandwidth level, and the third level is called as the best-effort level.

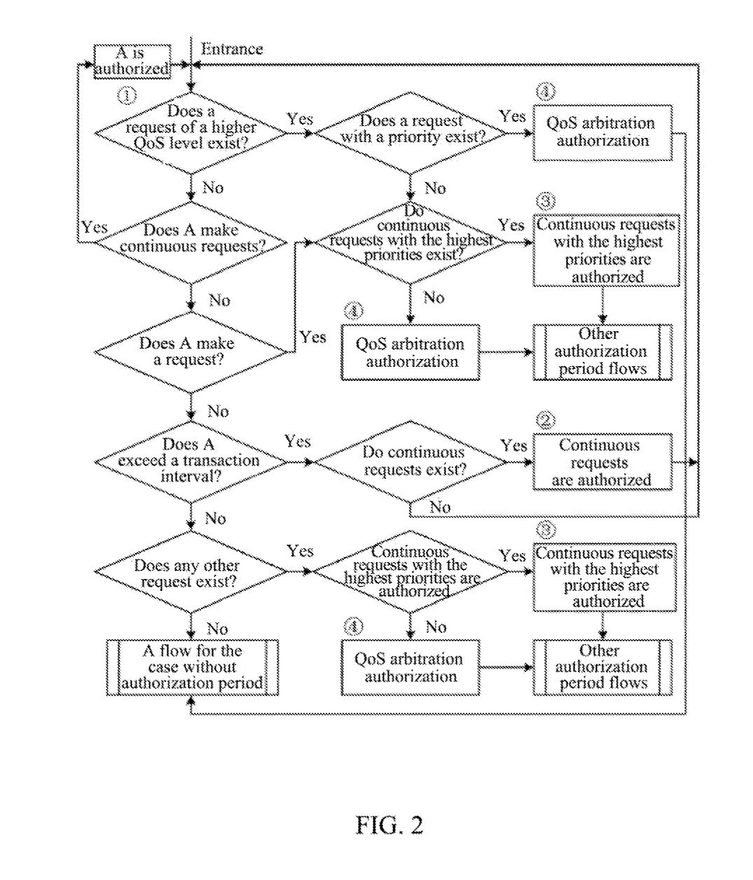

In the example, an arbitration process is in an authorization period of a certain device (assumed to be A), a work flow of the limited maintaining authorization arbitration module is as shown in FIGS. 2, and 4 authorization situations are included.

In situation 1, if a device of a QoS level higher than that of A does not make a request at present and A makes continuous requests, A is authorized (step \textcircled{1} in FIG. 2).

In situation 2, if a device of a QoS level higher than that of A does not make a request at present, and A does not make a request, and a request interval of A (i.e., a time interval between the current time and the moment at which A made a request last time) is less than a transaction interval of A, and there exists a certain device making continuous requests, the device making the continuous requests is authorized (step \textcircled{2} in FIG. 2); if there exist multiple requests which may be authorized, selection is made according to an LRS sequence; and if continuous requests do not exist, no device is authorized.

In situation 3, if A makes continuous requests but the requests are discontinuous, or A does not make a request and the request interval of A has exceeded the transaction interval of A, or a non-priority device of the current QoS level higher than that of A makes a request, and there exist continuous requests of the highest QoS level, the continuous requests of the highest QoS level are authorized (step \textcircled{3} in FIG. 2); if there exist multiple requests which may be authorized, selection is made according to an LRS sequence; and if A does not make a request and the request interval of A has exceeded the transaction interval of A, and no any other request exists, a flow for the case without the authorization period is executed.

In situation 4, if judgment conditions under the foregoing 3 situations are all false, arbitration is performed according to the QoS level and the LRS sequence (step \textcircled{4} in FIG. 2), and when there exists a request of a priority device, a flow for the case without the authorization period is executed after completing the step \textcircled{4}; but other authorization period flows are executed after the step \textcircled{4} in other situations;

the authorization is completed after the steps \textcircled{1} and \textcircled{2}; and other authorization period flows are executed after the step \textcircled{3}.

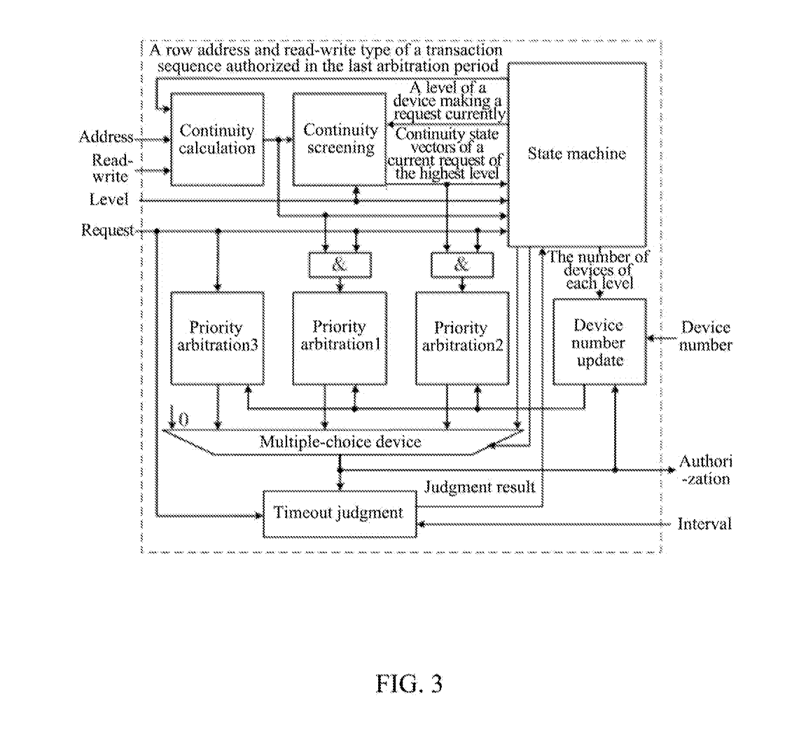

In order to facilitate the implementation of hardware, the fixed priority arbitration with a comparatively simple logic design is uniformly adopted to respectively calculate results of the last 3 authorization situations in the embodiment. A basic idea thereof is firstly calculating a priority order among all the devices according to the QoS level of each device and the current LRS sequence among devices of the same level, then screening out requests which do not meet the condition according to the categories of authorization situations adopted currently, and finally calculating a result of the currently adopted authorization situation with a fixed priority arbitration method according to the priority order of the devices and the screened-out requests. For example, a result of the above situation 2 can be calculated by screening out the discontinuous requests. Based on this idea, a hardware structure of the limited maintaining authorization arbitration module can be as shown in FIG. 3, which includes:

a continuity calculation unit, a continuity screening unit, a timeout judgment unit, priority arbitration units, a multiple-choice device, a device number update unit and a state machine; and each of these constitutional units will be described in detail below.

The continuity calculation unit is used to: obtain a row address last_addr and read-write type last_rw of a transaction sequence authorized in the last arbitration period from the state machine, calculate whether a row address of each request and a row address of the last authorized transaction are identical or access different memory banks and whether a read-write type of each request and a read-write type of the last authorized transaction are identical, and eventually obtain continuity calculation results corresponding to all the devices, wherein, 1 represents continuity and 0 represents discontinuity; the results form continuity vectors; and requests of the device of the first level are defaulted as discontinuous;

the continuity screening unit is used to: obtain a level h_req_lev of a device currently making a request from the state machine, and screen continuity state vectors continuityP of a current request of the highest level from the continuity vectors, that is, set all the continuity components of requests of other levels to be 0 among the continuity vectors, and send the continuity state vectors continuityP to the state machine; wherein, the level of the device currently making the request is obtained by the state machine performing calculation according to the priority order among all the devices and the request statuses;

the priority arbitration units are used to perform arbitration with a fixed arbitration method, and a first priority arbitration unit, a second priority arbitration unit and a third priority arbitration unit are included; the 3 priority arbitration units are instantiated in the FIG. 3, priority orders between the devices input by the 3 priority arbitration units are identical, but the request statuses are different, thus the 3 priority arbitration units are respectively used to calculate arbitration results of different authorization situations; the first priority arbitration unit inputs a request status of each device and a bitwise-and result of the continuity state vectors screened by the continuity screening unit, for calculating a first authorization result; the second priority arbitration unit inputs a request status of each device and a bitwise-and result of continuity vectors of a request of the device of the highest level, for calculating a second authorization result; and the third priority arbitration unit directly inputs a request status of each device, for calculating a third authorization result; wherein, the request status is that: 1 represents that a request is made, and 0 represents that there is no request;

the multi-choice device is used to: select one of the first authorization result, the second authorization result, the third authorization result and 0 to serve as a current authorization result to be output according to an indication of the state machine, and input the current authorization result to the timeout judgment unit and the device number update unit;

the device number update unit is used to: when the multi-choice device selects the current authorization result, according to the current authorization result, a number of devices of each level and an LRS sequence of devices of an identical level at the current moment obtained from the state machine, update a priority order among the devices for the next arbitration;

the timeout judgment unit is used to: calculate how many periods had passed from the moment at which a device currently in the authorization period (i.e., a device which is authorized in the last arbitration period) made the last request to the current moment, and judge whether a number of the periods exceeds a transaction interval of the device, and input a judgment result inv_exp to the state machine; wherein, the transaction interval of the device is required to be configured in the timeout judgment unit before work; and

An one-to-one correspondence exists between state information of the state machine and authorization periods, including two states: an authorization period and no authorization period of a certain device, no authorization period represents a period which is not within an authorization period of any device; the state machine is used to: determine an authorization situation which should be currently adopted by an arbiter according to state information of the state machine, the continuity vectors, the continuity state vectors, levels and the request statuses, and then indicate the multi-choice device to make choices; wherein, a judgment criterion of the authorization situation which should be currently adopted may refer to the above strategies or be as shown in FIG. 2, which will not be repeated here.

The ordinary person skilled in the art can understand that all or part of the steps in the above method can be completed by a program instructing related hardware, and the program can be stored in a computer readable memory medium, such as a read-only memory, disk or optical disk and so on. Alternatively, all or part of the steps of the above embodiments also can be implemented by using one or multiple integrated circuits. Correspondingly, each module/unit in the above embodiments can be implemented in a form of hardware, and also can be implemented in a form of software function module. The present invention is not limited to any combination of hardware and software in a specific form.

Certainly, the present invention can still have other various embodiments, the skilled familiar with the art can make various corresponding changes and transformations according to the present invention without departing from the spirit and essence of the present invention, and these corresponding changes and transformations shall all fall into the protection scope of the claims of the present invention.

### INDUSTRIAL APPLICABILITY

In the technical scheme of the embodiments of the present invention, the Slack-based QoS arbitration is improved, by continuously authorizing the sequences of the pending transactions sent by the same device and having the identical row addresses and read-write types in devices except the devices of the first level, it is guaranteed that this kind of transaction sequences are sent uninterruptedly to the memory controller, thereby reducing the times of the memory switching row addresses and read-write types and optimizing the memory access efficiency.

What is claimed is:

1. A method for on-chip bus arbitration, comprising:
dividing devices into a first level, a second level and a third level from high to low; and
in each arbitration period, executing the following steps:
calculating remaining processing time of each real-time transaction, and upgrading a device making a request required to be processed immediately to the first level in a current arbitration period;
monitoring a bandwidth usage amount of a device of the first level and a bandwidth usage amount of a device of the second level, and downgrading a device whose bandwidth usage amount exceeds a preset bandwidth threshold value to the third level in the current arbitration period; and
in devices making requests for a bus use right, when a device of a highest level is the device of the first level, authorizing the device of the first level; and when the device of the highest level is not the device of the first level, authorizing a device making continuous requests;
wherein, the continuous requests are requests whose read-write types are the same as that of a last authorized transaction, and whose addresses hit a same row or different memory banks as an address of the last authorized transaction does.

2. The method according to claim 1, wherein, the step of authorizing a device making continuous requests comprises:
if no authorization period device exists, authorizing a device making continuous requests among devices of the highest level;
if a device whose level is higher than that of the authorization period device makes a request, authorizing a device making continuous requests among devices of a higher level; and
when no device of the higher level makes a request, judging whether a authorization period device makes continuous requests, if the authorization period device makes the continuous requests, authorizing the authorization period device; and if the requests made by the authorization period device are discontinuous requests, authorizing a device making continuous requests among devices of the highest level;
wherein, the authorization period device refers to that:
when no authorization period device exists, and a device of the second level or a device of the third level is authorized, the authorized device is a authorization period device;
when a authorization period device exists, in a condition that the device whose level is higher than that of the authorization period device does not make a request, if the authorization period device makes continuous requests, or if the authorization period device does not make a request and a time interval between a current time and a moment at which the authorization period device made a request last time does not exceed a transaction interval of the authorization period device, the authorization period device is still a authorization period device; and
when a authorization period device exists and it is not the above case that the authorization period device is still a authorization period device, if a device of the second level or a device of the third level is authorized, the authorized device is a authorization period device;
wherein, the transaction interval is an interval existing between pending transactions sent by an identical device.

3. The method according to claim 2, wherein, the step of authorizing a device making continuous requests further comprises:
when a authorization period device exists and a device whose level is higher than that of the authorization period device does not make a request, if the authorization period device does not make a request, and when a time interval between a current time and a moment at which the authorization period device made a request last time does not exceed a transaction interval of the authorization period device, judging whether a device making continuous requests exists, if a device making continuous requests exists, authorizing the device making continuous requests, and if the device making continuous requests does not exist, not performing authorization.

4. The method according to claim 2, wherein, the step of authorizing a device making continuous requests further comprises:
when no device of the higher level makes a request, the authorization period device does not make a request and a time interval between a current time and a moment at which the authorization period device making a request last time exceeds a transaction interval of the authorization period device, judging whether other requests exist; if no any other request exists, not performing authorization; if other requests exist and a device of the highest level makes continuous requests, authorizing a device making continuous requests; and if no continuous requests made by the device of the highest level exist among the other requests, performing authorization according to a Least Recently Serviced (LRS) principle.

5. The method according to claim 2, wherein, the step of authorizing a device making continuous requests further comprises:
if no authorization period device exists and a device of the highest level does not make continuous requests, performing authorization according to the LRS principle;
if a device whose level is higher than that of the authorization period device does not make continuous requests, performing authorization according to the LRS principle; and
when no device of the higher level makes a request, and requests made by the authorization period device are discontinuous requests, if a device of the highest level does not make continuous requests, performing authorization according to the LRS principle.

6. A device for on-chip bus arbitration, comprising:
a setting module, configured to: divide devices into a first level, a second level and a third level from high to low;
a real-time scheduling module, configured to: in each arbitration period, calculate remaining processing time of each real-time transaction, and upgrade a device making a request required to be processed immediately to the first level in a current arbitration period;
a bandwidth allocation module, configured to: in each arbitration period, monitor a bandwidth usage amount of a device of the first level and a bandwidth usage amount of a device of the second level, and downgrade a device whose bandwidth usage amount exceeds a preset bandwidth threshold value to the third level in the current arbitration period; and
a limited maintaining authorization arbitration module, configured to: in each arbitration period, after the real-time scheduling module and the bandwidth allocation module adjust the levels, in devices making requests for a bus use right, when a device of a highest level is the device of the first level, authorize the device of the first level; and when the device of the highest level is not the device of the first level, authorize a device making continuous requests; wherein, the continuous requests are requests whose read-write types are the same as that of a last authorized transaction, and whose addresses hit a same row or different memory banks as an address of the last authorized transaction does.

7. The device according to claim 6, wherein, the limited maintaining authorization arbitration module is further configured to authorize the device making continuous requests by means of:
if no authorization period device exists, the limited maintaining authorization arbitration module authorizing a device making continuous requests among devices of the highest level;
if a device whose level is higher than that of the authorization period device makes a request, the limited maintaining authorization arbitration module authorizing a device making continuous requests among devices of a higher level; and
when no device of the higher level makes a request, the limited maintaining authorization arbitration module judging whether a authorization period device makes continuous requests, if the authorization period device makes the continuous requests, authorizing the authorization period device; and if the requests made by the authorization period device are discontinuous requests, authorizing a device making continuous requests among devices of the highest level;
wherein, the authorization period device refers to that:
when no authorization period device exists, and a device of the second level or a device of the third level is authorized, the authorized device is a authorization period device;
when a authorization period device exists, in a condition that the device whose level is higher than that of the authorization period device does not make a request, if the authorization period device makes continuous requests, or if the authorization period device does not make a request and a time interval between a current time and a moment at which the authorization period device made a request last time does not exceed a transaction interval of the authorization period device, the authorization period device is still a authorization period device; and
when a authorization period device exists and it is not the above case that the authorization period device is still a authorization period device, if a device of the second level or a device of the third level is authorized, the authorized device is a authorization period device;
wherein, the transaction interval is an interval existing between pending transactions sent by an identical device.

8. The device according to claim 7, wherein,
the limited maintaining authorization arbitration module is further configured to: when a authorization period device exists and a device whose level is higher than that of the authorization period device does not make a request, if the authorization period device does not make a request, and when a time interval between a current time and a moment at which the authorization period device made a request last time does not exceed a transaction interval of the authorization period device, judge whether a device making continuous requests exists, if a device making continuous requests exists, authorize the device making continuous requests, and if the device making continuous requests does not exist, not perform authorization.

9. The device according to claim 7, wherein,
the limited maintaining authorization arbitration module is further configured to: when no device of the higher level makes a request, the authorization period device does not make a request and a time interval between a current time and a moment at which the authorization period device made a request last time exceeds a transaction interval of the authorization period device, judge whether other requests exist; if no any other request exists, not perform authorization; if other requests exist and a device of the highest level makes continuous requests, authorize a device making continuous requests; and if no continuous requests made by the device of the highest level exist among the other requests, perform authorization according to a Least Recently Serviced (LRS) principle.

10. The device according to claim 6, wherein, the limited maintaining authorization arbitration module comprises: a continuity calculation unit, a continuity screening unit, a timeout judgment unit, priority arbitration units, a multiple-choice device, a device number update unit and a state machine; wherein:
the continuity calculation unit is configured to: obtain a row address and read-write type of a transaction sequence authorized in a last arbitration period from the state machine, calculate whether a row address of each request and a row address of the last authorized transaction are identical or access different memory banks and whether a read-write type of each request and a read-write type of the last authorized transaction are identical, and eventually obtain continuity calculation results corresponding to all the devices, wherein, 1 represents continuity and 0 represents discontinuity; the results form continuity vectors; and requests of the device of the first level are defaulted as discontinuous;
the continuity screening unit is configured to: obtain a level of a device currently making a request from the state machine, and screen continuity state vectors of a current request of the highest level from the continuity vectors, and send the continuity state vectors to the state machine;
the priority arbitration units comprise a first priority arbitration unit, a second priority arbitration unit and a third priority arbitration unit; the first priority arbitration unit is configured to: input a request status of each device and a bitwise-and result of the continuity state vectors screened by the continuity screening unit, and calculate a first authorization result; the second priority arbitration unit is configured to: input a request status of each device and a bitwise-and result of continuity vectors of a request of the device of the highest level, and calculate a second authorization result; and the third priority arbitration unit is configured to: directly input a request status of each device, and calculate a third authorization result; wherein, the request status is that: 1 represents that a request is made, and 0 represents that there is no request;
the multi-choice device is configured to: select one of the first authorization result, the second authorization result, the third authorization result and 0 to serve as a current authorization result to be output according to an indication of the state machine, and input the current authorization result to the timeout judgment unit and the device number update unit;
the device number update unit is configured to: when the multi-choice device selects the current authorization result, according to the current authorization result, a number of devices of each level and an LRS sequence of devices of an identical level at the current moment obtained from the state machine, update a priority order among the devices for the next arbitration;
the timeout judgment unit is configured to: calculate how many periods had passed from a moment at which a device in the authorization period made a last request to a current moment, and judge whether a number of the periods exceeds a transaction interval of the device, and input a judgment result to the state machine; and
the state machine is configured to: determine an authorization situation which should be currently adopted by an arbiter according to state information, the continuity vectors, the continuity state vectors, levels and the request statuses, and indicate the multi-choice device to make choices.

11. The device according to claim 7, wherein, the limited maintaining authorization arbitration module comprises: a continuity calculation unit, a continuity screening unit, a timeout judgment unit, priority arbitration units, a multiple-choice device, a device number update unit and a state machine; wherein:
the continuity calculation unit is configured to: obtain a row address and read-write type of a transaction sequence authorized in a last arbitration period from the state machine, calculate whether a row address of each request and a row address of the last authorized transaction are identical or access different memory banks and whether a read-write type of each request and a read-write type of the last authorized transaction are identical, and eventually obtain continuity calculation results corresponding to all the devices, wherein, 1 represents continuity and 0 represents discontinuity; the results form continuity vectors; and requests of the device of the first level are defaulted as discontinuous;
the continuity screening unit is configured to: obtain a level of a device currently making a request from the state machine, and screen continuity state vectors of a current request of the highest level from the continuity vectors, and send the continuity state vectors to the state machine;
the priority arbitration units comprise a first priority arbitration unit, a second priority arbitration unit and a third priority arbitration unit; the first priority arbitration unit is configured to: input a request status of each device and a bitwise-and result of the continuity state vectors screened by the continuity screening unit, and calculate a first authorization result; the second priority arbitration unit is configured to: input a request status of each device and a bitwise-and result of continuity vectors of a request of the device of the highest level, and calculate a second authorization result; and the third priority arbitration unit is configured to: directly input a request status of each device, and calculate a third authorization result; wherein, the request status is that: 1 represents that a request is made, and 0 represents that there is no request;
the multi-choice device is configured to: select one of the first authorization result, the second authorization result, the third authorization result and 0 to serve as a current authorization result to be output according to an indication of the state machine, and input the current authorization result to the timeout judgment unit and the device number update unit;
the device number update unit is configured to: when the multi-choice device selects the current authorization result, according to the current authorization result, a number of devices of each level and an LRS sequence of devices of an identical level at the current moment obtained from the state machine, update a priority order among the devices for the next arbitration;
the timeout judgment unit is configured to: calculate how many periods had passed from a moment at which a device in the authorization period made a last request to a current moment, and judge whether a number of the periods exceeds a transaction interval of the device, and input a judgment result to the state machine; and
the state machine is configured to: determine an authorization situation which should be currently adopted by an arbiter according to state information, the continuity vectors, the continuity state vectors, levels and the request statuses, and indicate the multi-choice device to make choices.

12. The device according to claim 8, wherein, the limited maintaining authorization arbitration module comprises: a continuity calculation unit, a continuity screening unit, a timeout judgment unit, priority arbitration units, a multiple-choice device, a device number update unit and a state machine; wherein:
the continuity calculation unit is configured to: obtain a row address and read-write type of a transaction sequence authorized in a last arbitration period from the state machine, calculate whether a row address of each request and a row address of the last authorized transaction are identical or access different memory banks and whether a read-write type of each request and a read-write type of the last authorized transaction are identical, and eventually obtain continuity calculation results corresponding to all the devices, wherein, 1 represents continuity and 0 represents discontinuity; the results form continuity vectors; and requests of the device of the first level are defaulted as discontinuous;
the continuity screening unit is configured to: obtain a level of a device currently making a request from the state machine, and screen continuity state vectors of a current request of the highest level from the continuity vectors, and send the continuity state vectors to the state machine;
the priority arbitration units comprise a first priority arbitration unit, a second priority arbitration unit and a third priority arbitration unit; the first priority arbitration unit is configured to: input a request status of each device and a bitwise-and result of the continuity state vectors screened by the continuity screening unit, and calculate a first authorization result; the second priority arbitration unit is configured to: input a request status of each device and a bitwise-and result of continuity vectors of a request of the device of the highest level, and calculate a second authorization result; and the third priority arbitration unit is configured to: directly input a request status of each device, and calculate a third authorization result; wherein, the request status is that: 1 represents that a request is made, and 0 represents that there is no request;
the multi-choice device is configured to: select one of the first authorization result, the second authorization result, the third authorization result and 0 to serve as a current authorization result to be output according to an indication of the state machine, and input the current authorization result to the timeout judgment unit and the device number update unit;
the device number update unit is configured to: when the multi-choice device selects the current authorization result, according to the current authorization result, a number of devices of each level and an LRS sequence of devices of an identical level at the current moment obtained from the state machine, update a priority order among the devices for the next arbitration;
the timeout judgment unit is configured to: calculate how many periods had passed from a moment at which a device in the authorization period made a last request to a current moment, and judge whether a number of the periods exceeds a transaction interval of the device, and input a judgment result to the state machine; and
the state machine is configured to: determine an authorization situation which should be currently adopted by an arbiter according to state information, the continuity vectors, the continuity state vectors, levels and the request statuses, and indicate the multi-choice device to make choices.

13. The device according to claim 9, wherein, the limited maintaining authorization arbitration module comprises: a continuity calculation unit, a continuity screening unit, a timeout judgment unit, priority arbitration units, a multiple-choice device, a device number update unit and a state machine; wherein:
the continuity calculation unit is configured to: obtain a row address and read-write type of a transaction sequence authorized in a last arbitration period from the state machine, calculate whether a row address of each request and a row address of the last authorized transaction are identical or access different memory banks and whether a read-write type of each request and a read-write type of the last authorized transaction are identical, and eventually obtain continuity calculation results corresponding to all the devices, wherein, 1 represents continuity and 0 represents discontinuity; the results form continuity vectors; and requests of the device of the first level are defaulted as discontinuous;
the continuity screening unit is configured to: obtain a level of a device currently making a request from the state machine, and screen continuity state vectors of a current request of the highest level from the continuity vectors, and send the continuity state vectors to the state machine;
the priority arbitration units comprise a first priority arbitration unit, a second priority arbitration unit and a third priority arbitration unit; the first priority arbitration unit is configured to: input a request status of each device and a bitwise-and result of the continuity state vectors screened by the continuity screening unit, and calculate a first authorization result; the second priority arbitration unit is configured to: input a request status of each device and a bitwise-and result of continuity vectors of a request of the device of the highest level, and calculate a second authorization result; and the third priority arbitration unit is configured to: directly input a request status of each device, and calculate a third authorization result; wherein, the request status is that: 1 represents that a request is made, and 0 represents that there is no request;
the multi-choice device is configured to: select one of the first authorization result, the second authorization result, the third authorization result and 0 to serve as a current authorization result to be output according to an indication of the state machine, and input the current authorization result to the timeout judgment unit and the device number update unit;
the device number update unit is configured to: when the multi-choice device selects the current authorization result, according to the current authorization result, a number of devices of each level and an LRS sequence of devices of an identical level at the current moment obtained from the state machine, update a priority order among the devices for the next arbitration;
the timeout judgment unit is configured to: calculate how many periods had passed from a moment at which a device in the authorization period made a last request to a current moment, and judge whether a number of the periods exceeds a transaction interval of the device, and input a judgment result to the state machine; and
the state machine is configured to: determine an authorization situation which should be currently adopted by an arbiter according to state information, the continuity vectors, the continuity state vectors, levels and the request statuses, and indicate the multi-choice device to make choices.
